(19) United States
(12) Patent Application Publication
(10) Pub. No.: US 2026/0073451 A1
(43) Pub. Date: Mar. 12, 2026

(54) Automated System and Method for Title Examination and Insurance Policy Generation

(71) Applicants: Robert Ruloff, Virginia Beach, VA (US); Marites Ruloff, Virginia Beach, VA (US)

(72) Inventors: Robert Ruloff, Virginia Beach, VA (US); Marites Ruloff, Virginia Beach, VA (US)

(21) Appl. No.: 18/958,169

(22) Filed: Nov. 25, 2024

Related U.S. Application Data
(60) Provisional application No. 63/693,223, filed on Sep. 11, 2024.

(51) Int. Cl. G06Q 40/08

(52) U.S. Cl. CPC G06Q 40/08

(57) ABSTRACT

The present invention relates to a title insurance policy writing system and software application designed to automate and streamline the workflow of title examination and policy creation. The system features a data input module that collects title examination data, either manually or from external sources like public records. A data processing module formats the data for policy generation and an underwriting rule engine applies regulatory guidelines to ensure compliance. The system also includes a policy generation module that uses predefined templates to create title insurance policies and a reporting and audit module for generating compliance reports. The invention combines the title examination and policy writing steps into a single automated workflow eliminating manual interpretation of the examination notes.

### CROSS-REFERENCE TO RELATED APPLICATION

The present application claims priority to, and the benefit of, U.S. Provisional Application No. 63/693,223, which was filed on Sep. 11, 2024, and is incorporated herein by reference in its entirety.

### FIELD OF THE INVENTION

The present invention generally relates to title insurance systems. More specifically, the invention relates to an automated title insurance policy writing system designed to streamline the workflow of title examination and policy creation. The system includes a software application installed on electronic devices or accessed via a web browser, a data input module that collects title examination information such as property details and liens. A data processing module structures the information for policy generation, an underwriting rule engine applies regulatory guidelines for compliance. The system automates policy creation using customizable templates and reduces manual errors. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, the process of real estate title examination and underwriting is traditionally a time-consuming and labor-intensive task. Title examiners are responsible for reviewing property records, ownership history, liens, and legal encumbrances, while underwriters use these examination results to create title insurance policies. However, the conventional process is prone to errors that can lead to significant inefficiencies. Underwriters commonly misinterpret or misread the title examiner's search notes. Such notes often contain detailed and complex legal descriptions of the property and any misunderstanding of this information can result in mistakes in the underwriting process. Accordingly, the process may need to be repeated, effectively doubling the time and effort required to issue a correct title insurance policy. Additionally, inaccuracies in property descriptions can cause the issuance of incorrect policies which may expose the insurer and the policyholder to risk. Such errors can also lead to legal complications. People desire a system to streamline and automate the title examination and underwriting process to reduce human error and save time.

Therefore, there exists a long-felt need in the art for a system that streamlines the process of title examination and insurance policy creation. There is a long-felt need for a system that automates the transfer of examination data into policy documents to minimize errors, save time, and increase the accuracy of title insurance policies. Additionally, there is a need for a system that can integrate underwriting guidelines and ensure compliance with legal standards without requiring extensive manual intervention. Moreover, there is a long-felt need for a system that can offer real-time collaboration between title examiners and underwriters to improve workflow efficiency. Further, there is a need for a system that can provide flexible options for exporting and managing policy documents across various devices and platforms. Further, there is a need for a system that saves time and effort when creating insurance policies by reducing the number of mistakes that occur between examination and underwriting.

The subject matter disclosed and claimed herein, in one embodiment, comprises an automated title insurance policy writing system. The system includes a software application that can be installed on electronic devices, such as computers, tablets, or smartphones, and accessed via a web browser. The system features a data input module that automatically gathers data from title examination processes, including property descriptions, ownership history, liens, and encumbrances. A data processing module structures the raw data for policy generation and an underwriting rule engine applies regulatory guidelines to ensure compliance with industry standards. The system also includes a policy generation module that populates pre-defined templates with processed data, creating accurate title insurance policies. Furthermore, the system allows for real-time collaboration between users and offers flexible export options, including digital signing and direct email distribution to clients.

In this manner, the automated title insurance policy writing system of the present invention addresses the long-felt need for reducing errors and delays in the title insurance creation process. The system automates the data transfer between title examination and underwriting and therefore enhances efficiency, saves time, and ensures the accuracy of policies. The system represents a significant improvement over traditional, manual methods of title insurance policy creation, offering a streamlined and reliable solution for title examiners and underwriters.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated title insurance policy writing system. The system comprises a software application configured to be installed on an electronic computing device, a data input module adapted to collect data from a title examination process, wherein the data includes property descriptions, ownership history, liens, and legal encumbrances, a data processing module adapted to process the data from the data input module, an underwriting rule engine configured to automatically apply underwriting guidelines and regulations to the processed data and check for compliance with legal and industry standards, and a policy generation module configured to populate the processed and validated data into a predefined insurance policy template and generate a title insurance policy based on the data and applicable underwriting rules.

In another aspect, a method for automating the creation of a title insurance policy is disclosed. The method includes the steps of collecting data related to a property title examination, wherein the data includes at least property descriptions, ownership history, liens, and legal encumbrances, processing the collected data to parse and structure it into a format suitable for title policy generation, applying underwriting rules to the processed data to check for compliance with legal and industry standards, identifying and flagging errors or discrepancies in the processed data, and automatically generating a title insurance policy by populating the processed and validated data into a predefined insurance policy template. The method automates the data transfer between title examination and underwriting for enhancing efficiency, saving time, and ensuring the accuracy of policies.

In another embodiment, a title insurance policy writing system is disclosed. The title insurance policy writing system includes a software application, a server system which includes a data input module adapted to automatically collect data from external sources such as public records, title search systems, and county databases, a data processing module adapted to format the collected data into a structure usable for title insurance policy creation, an underwriting rule engine configured to apply underwriting rules to the formatted data to identify any discrepancies or errors, and automatically correct or flag such errors for human review, and a reporting and audit module configured to generate compliance reports and audit records for title insurance policies created by the system.

In another embodiment, a method for generating title insurance policies is disclosed. The method includes the steps of retrieving title examination data from external databases, title search systems, or public records, formatting the retrieved data into a structure usable for policy creation, applying underwriting guidelines and legal regulations to the formatted data to check for policy compliance, generating a title binder based on the formatted data and underwriting rules, creating one or more title insurance policy documents using the generated title binder, and providing an option for exporting the generated title insurance policy documents in multiple formats, including PDF and Word.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of title insurance policies writing system of the present invention in accordance with the disclosed architecture;

FIG. 2 illustrates an exemplary user interface for title examiners to enter or review data related to property title examination in accordance with one embodiment of the present invention;

FIG. 3 illustrates another exemplary interface displayed by the software application for policy generation in accordance with the disclosed architecture;

FIG. 4 illustrates an exemplary user interface provided by the application for policy export in accordance with the disclosed architecture; and

FIG. 5 illustrates a flow chart depicting a process of performing title examination and policy writing in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that streamlines the process of title examination and insurance policy creation. There is a long-felt need for a system that automates the transfer of examination data into policy documents to minimize errors, save time, and increase the accuracy of title insurance policies. Additionally, there is a need for a system that can integrate underwriting guidelines and ensure compliance with legal standards without requiring extensive manual intervention. Moreover, there is a long-felt need for a system that can offer real-time collaboration between title examiners and underwriters to improve workflow efficiency. Further, there is a need for a system that can provide flexible options for exporting and managing policy documents across various devices and platforms. Further, there is a need for a system that saves time and effort when creating insurance policies by reducing the number of mistakes that occur between examination and underwriting.

The present invention, in one exemplary embodiment, is a method for automating the creation of a title insurance policy. The method includes the steps of collecting data related to a property title examination, wherein the data includes at least property descriptions, ownership history, liens, and legal encumbrances, processing the collected data to parse and structure it into a format suitable for title policy generation, applying underwriting rules to the processed data to check for compliance with legal and industry standards, identifying and flagging errors or discrepancies in the processed data, and automatically generating a title insurance policy by populating the processed and validated data into a predefined insurance policy template.

Reference will now be made in detail to the present preferred embodiments of the invention, examples of which are illustrated in the accompanying drawings. Wherever possible, the same reference numerals are used in the drawings and the description to refer to the same or like parts.

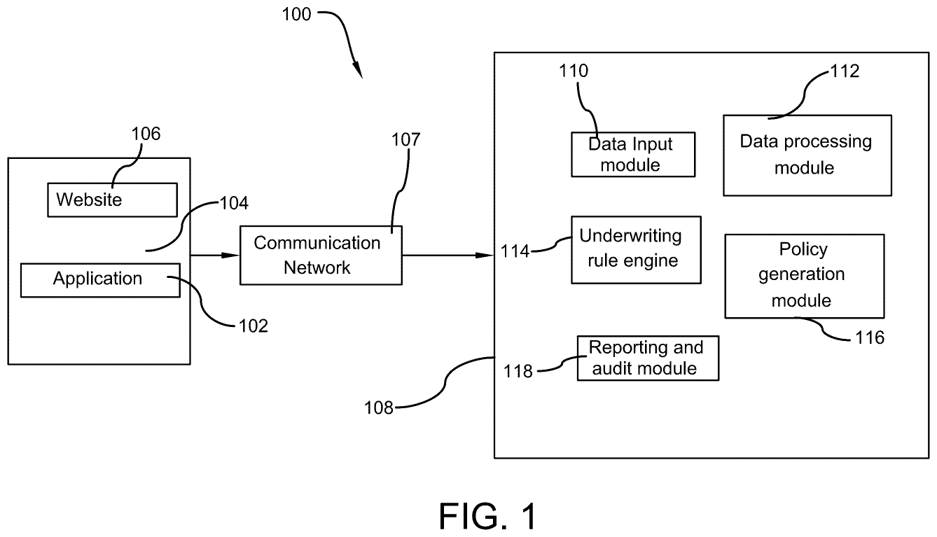

Referring initially to the drawings, FIG. 1 illustrates a block diagram view of title insurance policies writing system 100 of the present invention in accordance with the disclosed architecture. The integrated title examination and policy writing software system 100 of the present invention is designed to streamline the workflow of title examination and policy writing. More specifically, the title insurance policies writing system 100 combines the steps of title examination and policy writing into a single automated workflow.

The system 100 includes a software application 102 adapted to be installed in an electronic computing device 104 such as but not limited to a smartphone, a tablet, etc. A website 106 is also configured to provide the similar functionality and can be accessed using a web browser (via communication network 107). The application 102 and the website 106 provide one or more user interfaces using which title examiners and underwriters interact with the system 100.

A server system 108 includes a data input module 110 which is adapted to collect data from the title examination process. The data input module 110 includes information such as but not limited to property descriptions, ownership history, liens, and any legal encumbrances. In the preferred embodiment, the data input module 110 automatically imports information from existing databases, title search systems, or other external sources like county records or public registries. In some embodiments, the information in the module 110 can also be included/inputted manually by the title examiners.

A data processing module 112 is adapted to process and structure the raw data from the data input module 110 into a format suitable for title policy creation. The module 112 parses raw text such as but not limited to legal descriptions or liens into formats used as per legal requirements. The module 112 can also identify inconsistencies or errors during data processing for human review. An underwriting rule engine 114 incorporates underwriting guidelines and regulations into the system 100. The underwriting rule engine 114 checks the processed data against the rules stored therein to review the policy for compliance with legal and industry standards. The engine 114 reduces the need for manual intervention by automatically applying underwriting rules to the gathered data, further preventing human errors in policy generation. When an issue is detected by the engine 114, the system 100 preferably and automatically corrects the issue or flags the issue for review by a human underwriter or title examiner when is not automatically corrected by the system 100.

A policy generation module 116 includes a plurality of insurance policy templates and is adapted to receive the parsed and validated data from the processing module 112. The policy generation module 116 populates the data into one or more pre-defined insurance policy templates. Based on underwriting rules (as per engine 114) and geographic locations, templates can be automatically customized by the policy generation module 116. The templates can be updated in real time based on the new regulations and each template used in the policy generation module 116 includes clauses for ownership and rights and sections for exceptions and special conditions based on title examination results.

A reporting and audit module 118 generates reports and audits related to the policies created by the title examination and insurance policy generation automated system 100. The reports can be used for reviewing the compliance of the generated policies with internal or external audit requirements. The system 100 allows a plurality of users such as examiners and underwriters to work on the same policy in real time. Further, back-ups are created for each policy and are stored in the system 100 for redundancy of information.

In some embodiments of the present invention, the software application 102 may include the data processing module 112, underwriting rule engine 114, and policy generation module 116 allowing an offline operation of the system 100. The system 100 and the application 102 eliminate the need to manually interpret the examination notes before drafting the insurance policy by automatically entering the gathered examination information directly into the policy without further intervention.

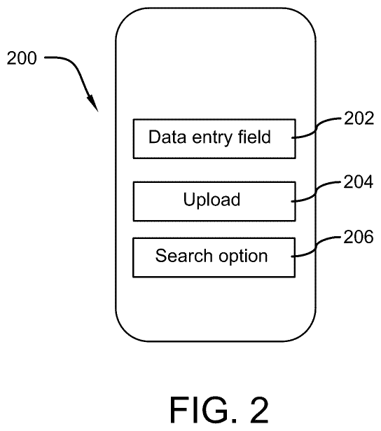

FIG. 2 illustrates an exemplary user interface for title examiners to enter or review data related to property title examination in accordance with one embodiment of the present invention. The interface 200 includes a data entry field box 202 for inputting property details and ownership history or any other information. An upload option 204 enables examiners to upload any relevant property documents like title deeds, reports, or surveys. A search option 206 allows the examiners to connect to third party sources to pull relevant property data from public records or title databases.

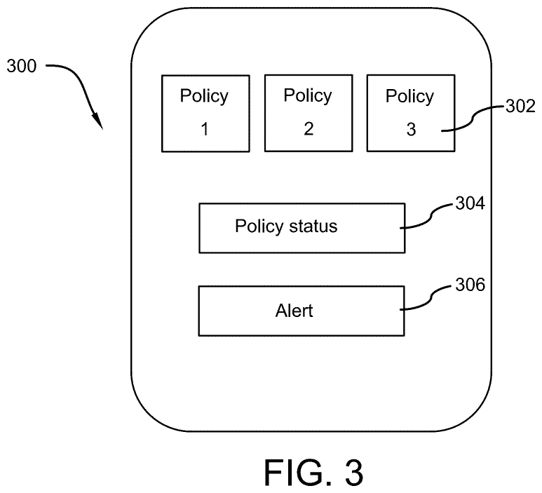

FIG. 3 illustrates another exemplary interface displayed by the software application for policy generation in accordance with the disclosed architecture. A plurality of customized policy options 302 are displayed on the interface 300 and a user can select any specific template from the displayed options. A policy status overview icon 304 is included in the interface 300 and provides a real-time status such as in-progress, completed, needs review for the policy being generated for a property. An alert 306 is automatically generated and displayed by the application 102 when any discrepancies or missing data are found before the policy can be generated.

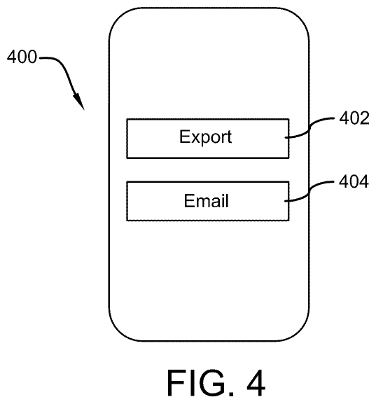

FIG. 4 illustrates an exemplary user interface provided by the application for policy export in accordance with the disclosed architecture. An export option 402 is provided by the interface 400 and allows users to export the policy in multiple formats such as PDF, Word, and more. An email option 404 allows a user to send the policy directly to the client via email or upload it to a secure client portal for retrieval. For digital signing of the policy documents, a digital sign option 406 is provided which allows users to electronically sign the policy documents.

The software captures and inputs title examination data directly into the insurance policy, avoiding the need for underwriters to manually analyze examiner notes, thereby minimizing the mistakes commonly made between the examination and underwriting phases. By automating the data transfer and interpretation, the software speeds up the policy creation process, saving time for both title examiners and underwriters.

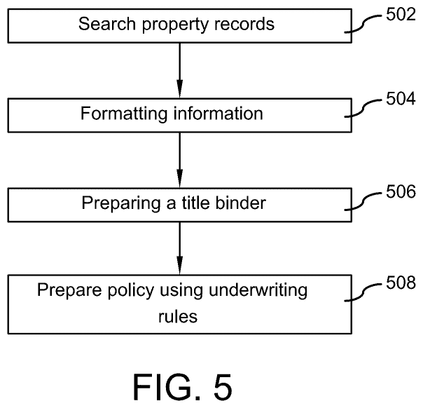

FIG. 5 illustrates a flow chart depicting a process of performing title examination and policy writing in accordance with one embodiment of the present invention. Initially, records for a property title are searched using the third party sources wherein information such as current owner, previous owners, heirs, tax liens and more (Step 502). The retrieved information is formatted and is made in usable form for title policy documents (Step 504). Thereafter, the information is used for making a title binder which is a temporary insurance contract that provides coverage for a property until the final title insurance policy is issued (Step 506). One or more title policy documents are prepared using the information based on the underwriting rules and regulations which can be used by operators and examiners for their clients (Step 508).

In some embodiments, the system 100 can suggest possible corrections or offer pre-defined solutions for common errors found in the policy documents. The system 100 also provides the ability for users to manually override the errors if the errors deem insignificant or provide justifications for proceeding.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “title examination and insurance policy generation automated system”, “title insurance policies writing system”, “integrated title examination and policy writing software system”, and “system” are interchangeable and refer to the integrated title examination and policy writing software system 100 of the present invention.

Notwithstanding the forgoing, the integrated title examination and policy writing software system 100 of the present invention can be of any suitable size and configuration as is known in the art without affecting the overall concept of the invention, provided that it accomplishes the above stated objectives. One of ordinary skill in the art will appreciate that the integrated title examination and policy writing software system 100 as shown in the FIGS. are for illustrative purposes only, and that many other sizes and shapes of the integrated title examination and policy writing software system 100 are well within the scope of the present disclosure. Although the dimensions of the integrated title examination and policy writing software system 100 are important design parameters for user convenience, the integrated title examination and policy writing software system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A title examination and insurance policy generation automated system comprising:
a software application adapted to combine a title examination and a policy writing into a single automated workflow;
a policy generation module configured to populate a validated data into a pre-defined insurance policy template, wherein the pre-defined insurance policy template is automatically customized based on a geographic location and an underwriting rule; and
a server system comprising:
a data input module configured to collect and import a title examination data,
a data processing module configured to process and structure an imported data, and
an underwriting rule engine configured to review a processed data against underwriting guidelines and regulations.

2. The title examination and insurance policy generation automated system of claim 1 further comprised of a website.

3. The title examination and insurance policy generation automated system of claim 1, wherein the data input module is configured to import a data from a title search system, a public registry, or a county record.

4. The title examination and insurance policy generation automated system of claim 1, wherein the underwriting rule engine is adapted to automatically correct an identified issue.

5. The title examination and insurance policy generation automated system of claim 1, wherein the underwriting rule engine is adapted to flag an identified issue for manual review.

6. The title examination and insurance policy generation automated system of claim 1 further comprised of a reporting and audit module.

7. The title examination and insurance policy generation automated system of claim 6, wherein the reporting and audit module generates a compliance report.

8. The title examination and insurance policy generation automated system of claim 1, wherein the policy generation module is configured to update the policy template in real time based on a regulatory change.

9. A method of using a title examination and insurance policy generation automated system, the method comprising the following steps:
collecting a title examination data from an external source via a data input module;
processing the title examination data into a format suitable for creating a policy, using a data processing module;
reviewing a processed title examination data for compliance with an underwriting rule of an underwriting rule engine to generate a compliance review; and
generating a title insurance policy by populating the processed title examination data into a pre-defined insurance policy template based on the compliance review.

10. The method of using a title examination and insurance policy generation automated system of claim 9, wherein the external source is comprised of a public record.

11. The method of using a title examination and insurance policy generation automated system of claim 9 further comprising flagging an inconsistencies in the processed title examination data for a manual review.

12. The method of using a title examination and insurance policy generation automated system of claim 9, wherein the pre-defined insurance policy template is customized based on a geographic location of the property.

13. The method of using a title examination and insurance policy generation automated system of claim 9 further comprised of exporting a generated title insurance policy in a digital format.

14. The method of using a title examination and insurance policy generation automated system of claim 13 further comprised of electronically signing the generated title insurance policy.

15. A method of using a title examination and insurance policy generation automated system, the method comprising the following steps:
collecting a title examination data from an external database or a manual input;
automatically processing the title examination data and identifying an inconsistency for a human review;
applying an underwriting rule to a processed title examination data to ensure compliance;
generating a title insurance policy by populating the processed title examination data that has been validated data by the underwriting rule into a pre-defined template; and
exporting the title insurance policy in one or more digital formats.

16. The method of using a title examination and insurance policy generation automated system of claim 15 further comprising a step of storing a backup of the generated policy.

17. The method of using a title examination and insurance policy generation automated system of claim 15 further comprising a step of allowing a plurality of users to collaborate while generating the title insurance policy.

18. The method of using a title examination and insurance policy generation automated system of claim 15 further comprising a step of automatically generating an alert when a data discrepancies is detected before the title insurance policy is generated.

19. The method of using a title examination and insurance policy generation automated system of claim 15 further comprising a step of automatically generating an alert when a missing information is detected before the title insurance policy is generated.

20. The method of using a title examination and insurance policy generation automated system of claim 15 further comprising a step of exporting the title insurance policy to a secure client portal.
